(19) United States
(12) Patent Application Publication
(10) Pub. No.: US 2003/0009481 A1
(43) Pub. Date: Jan. 9, 2003

(54) Method and apparatus to merge information

(76) Inventor: Victor Greenberg, Fremont, CA (US)

Correspondence Address: CHARLES MIRHO, 112 W. 37TH ST., VANCOUVER, WA, 98660, US

(21) Appl. No.: 09/886,168

(22) Filed: Jun. 20, 2001

(51) Int. Cl. G06F 12/00

(52) U.S. Cl. 707/200

(57) ABSTRACT

A method includes comparing a first and second files, and merging the first and second files according to the contents of a third file to produce a merged file. Priority is given to preserving the differences between the first and third files.

### COPYRIGHT NOTICE

This document contains material which is subject to copyright protection. The copyright owner has no objection to the facsimile reproduction of the material contained herein as it appears in the Patent and Trademark Office files or records, but otherwise reserves all rights whatsoever in the copyright.

### FIELD

The invention relates generally to merging information, and more particularly to merging information from at least three sources.

### BACKGROUND

Modern software production may be a complex, time consuming affair. In order to reduce design time and increase reliability, software developers have increasingly turned to the use of tools which assist in the software production process. One example of such a tool is the Visual Studio which is produced and sold by Microsoft Corporation of Redmond, Wash. Visual Studio includes an integrated development environment including a source code editor, compiler, linker, and run-time debugger for programming languages such as the C and C++ languages.

One type of software design tool is the “wizard” or wizard application. A wizard is software which produces other software. A wizard may prompt a software developer for information, typically through a graphical user interface, in response to which the developer supplies information to the wizard. The wizard may then employ this information, known as options or settings, to produce software. For example, a wizard may prompt a user to specify a feature, such as 3D controls or reference counting. Once the developer specifies the feature, the wizard may then produce the source code statements and other symbols to implement the feature. Of course the wizard may request additional information from the developer, such as the name of a file in which to store the produced software.

The developer may wish to modify, add, or remove features from the software produced by the wizard. However, the developer may subsequently modify the produced software using means other than the wizard. It may be difficult to employ the wizard on this subsequently modified software to add, remove, or modify features, without losing or damaging the subsequent modifications.

### FIGURES

The invention may be better understood with reference to the following figures in light of the accompanying description. The present invention, however, is limited only by the scope of the claims at the concluding portion of the specification.

FIG. 1 shows a method embodiment in accordance with the present invention.

FIG. 2 shows an embodiment of merge rules in accordance with the present invention.

FIG. 3 shows an embodiment of merge rules in accordance with the present invention.

FIG. 4 shows an embodiment of merge rules in accordance with the present invention.

FIG. 5 shows an embodiment of merge rules in accordance with the present invention.

FIG. 6 shows an embodiment of merge rules in accordance with the present invention.

FIG. 7 shows an embodiment of merge rules in accordance with the present invention.

FIG. 8 shows an embodiment of merge rules in accordance with the present invention.

FIG. 9 shows an embodiment of merge rules in accordance with the present invention.

FIG. 10 shows a system embodiment in accordance with the present invention.

### DESCRIPTION

In the following description, numerous references to “one embodiment” or “an embodiment” do not necessarily refer to the same embodiment, although they may. In the figures, like numbers refer to like elements.

Those skilled in the art will appreciate that embodiments of the present invention could comprise and software, hardware, and firmware, or any combination thereof.

In general, the contents of a first file and a second file are compared. The contents of the first and second files are merged according to the content of a third file, with priority given to preserving differences between the second and third files.

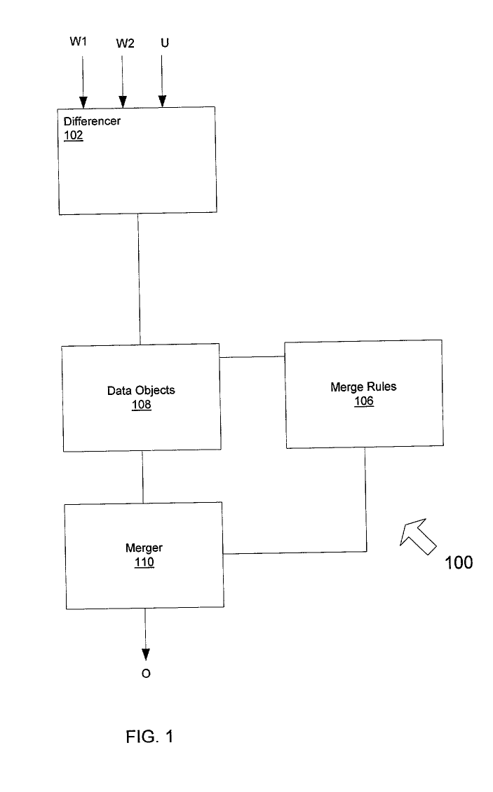

FIG. 1 shows a method embodiment in accordance with the present invention. A first wizard-produced file W1, a second wizard-produced file W2, and a user-modified version U of the first wizard-produced file W1 are input to a differencer 102. The first wizard-produced file W1 may comprise source code statements and other symbols produced by a first application of a wizard, to implement a feature in software. Subsequently, addition, modification, or removal of symbols from the file W1 may result from operations not involving the wizard, resulting in file U. This file U may henceforth may be referred to as the “user-modified file”. For example, a user, such as a person responsible for developing the software (a software developer), might make changes “by hand” to the file W1, although of course the modifications need not come directly from a “user” or other person. The second wizard-produced file W2 may comprise source code statements and other symbols added by a second application of the same or a different wizard, to implement a second feature in software different from the first feature in some regard. The present invention may be applied to merge the user changes to the file W1 into the file W2.

The differencer 102 may be any hardware, software, firmware, or combination thereof, comprising logic to determine the differences between two sets of source code. In one embodiment, differencer 102 determines a first difference between W1 and U, and a second difference between files W2 and U. In one embodiment, the differencer 102 may comprise the well-known “diff” or “diff2” operation.

A result of applying differencer 102 to the files W1, W2, and U is that a set of data objects 108 may be produced. Data objects 108 organize the information content of the files and the differences between the files, such that the merge rules 106 are facilitated in directing the operation of merger 110. The following table describes one embodiment of data objects according to the present invention. Of course, other embodiments may comprise greater, fewer, or different data objects, or data objects organized in a different manner.

| Object | Comprises | Application |
|---|---|---|
| LineInfo | Includes information about | A LineInfo object is created |
| | a specific line. | for each line of each file |
| | | W1, W2, and U. |
| Diff | Includes information about | A Diff object is created for |
| | a difference between two | each difference between |
| | files. | two files. |
| FileInfo | Includes a collection of | Four FileInfo objects are |
| | LineInfo objects. | created. Two FileInfo |
| | Includes two collections of | objects are created to |
| | Diff objects. | represent W1. One W1 |
| | | FileInfo object is applied to |
| | | the comparison of W1 and |
| | | W2; another W1 object is |
| | | applied to the comparison |
| | | of W1 and U. Other |
| | | FileInfo objects are created |
| | | to represent W2 and U. |
| | | One collection of Diff |
| | | objects represents the |
| | | differences between W1 |
| | | and W2. The other |
| | | collection of Diff objects |
| | | represents the differences |
| | | between W1 and U. |
| Edit | Includes information about | The merge rules create an |
| | a modification to apply to | Edit object for each |
| | W2. | modification to make to W2 |
| | | in order to produce the |
| | | merged file O. |
| AutoMergeObj | Includes a collection of | Creates the merged file O |
| | FileInfo objects. | by creating the FileInfo |
| | Includes a collection of Edit | objects, which in turn |
| | objects. | create the LineInfo and Diff |
| | | objects for the files. Also |
| | | applies the merge rules to |
| | | create the Edit objects, |
| | | which are applied to W2 to |
| | | create the merged file O. |

The merge rules 106 may be any hardware, software, firmware, or combination thereof, comprising logic to direct the merger 110 the contents of U and W2 according to the contents of W1, with priority given to preserving differences between W1 and U. The merger 110 may be any hardware, software, firmware, or combination thereof comprising logic to merge the contents of W2 and U according to the direction of merge rules 106. A file O representing the merged contents of files W2 and U may be produced by merger 110.

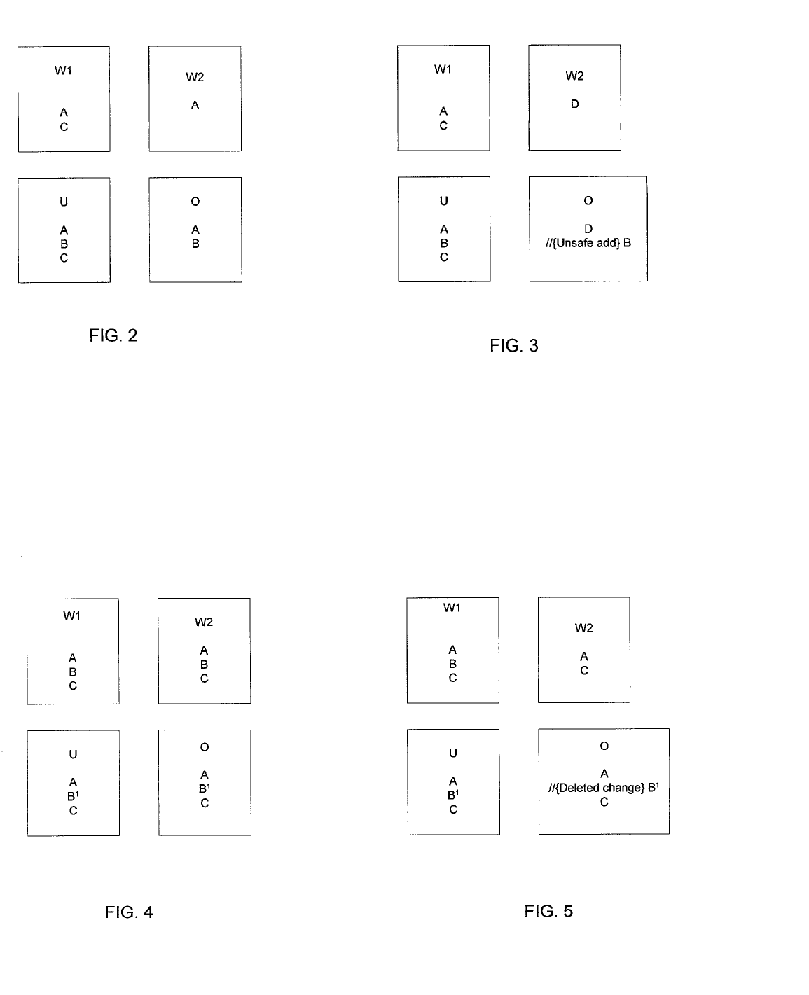

FIG. 2 shows an embodiment of merge rules 106 to merge the contents of the second wizard-produced file W2 and the user-modified file U, when the user-modified file U has lines not present in the second wizard-produced file W2. The user-modified file U comprises lines A,B, and C, and the second wizard-produced file W2 comprises the same line A; lines B,C from the user-modified file U are not present in the second wizard-produced file W2. The first wizard-produced file W1 comprises lines A,C. Thus, the user modifications to the first wizard-produced file W1 comprise addition of line B. The rules determine that the merged file O comprises the line A from the second wizard-produced file, and the line B which was added to the user-modified file U. Under these circumstances it may be determined that line C was added by the first application of the wizard to the source file, but not the second, and thus line C is not included in the merged file O.

FIG. 3 shows an embodiment of merge rules 106 to merge the contents of the second wizard-produced file W2 and the user-modified file U, when a line B has been added to the user-modified file B, but the lines surrounding line B (e.g. the context of line B) cannot be ascertained with certainty in the file W2. The user-modified file U comprises lines A, B, C, but the second wizard-produced file W2 comprises none of the same lines, but instead comprises line D not found in the user-modified file U. The first wizard-produced file comprises lines A, C. Thus, the user modifications to the first wizard-produced file W1 comprises addition of line B. However, it is not possible to know with certainty where line B should be included into the merged file O, because the context of line B is missing from the second wizard-generated file O. Thus, the line B is included in the merged file O, with the comment//{Unsafe add} to indicate that addition of the line B at this point in the merged file is subject to substantial uncertainty. The rules determine that the merged file O comprises the line D from the second wizard-produced file. Under these circumstances it may be determined that lines A,C were added by the first application of the wizard to the source file, but not the second, and thus lines A,C are not included in the merged file O.

FIG. 4 shows an embodiment of merge rules 106 to merge the contents of the second wizard-produced file W2 and the user-modified file U, when the user-modified file U includes modifications to a line B in the first wizard-produced file W1. The user-modified file U comprises lines A, B¹, C, where B¹ represents a modified version of line B of the first wizard-produced file. In other words, line B¹ occupies the same relative location in U as line B did in W1. The second wizard-produced file W2 comprises the same lines A,C as file U, and the unmodified line B not found in the user-modified file U. The first wizard-produced file W1 comprises lines A,B,C. Thus, the user modifications to the first wizard-produced file W1 comprise modification of line B. The rules determine that the merged file O comprises the lines A,C from the second wizard-produced file, and the line B¹ which was modified in the user-modified file U. Under these circumstances it may be determined that line B was added by both the first and second application of the wizard to the source file, and subsequent to the first application of the wizard, line B was modified by the user.

FIG. 5 shows an embodiment of merge rules 106 to merge the contents of the second wizard-produced file W2 and the user-modified file U, when a user-modified line is not present in the second wizard-produced file W2. The user-modified file U comprises lines A, B¹, C, and the second wizard-produced file W2 comprises the same lines A,C; line B¹ from the user-modified file U is not present in the second wizard-produced file W2. The first wizard-produced file comprises lines A,B, C. Thus, the user modifications to the first wizard-produced file W1 comprises modification of line B. It is not possible to know with certainty whether or not deleting the changed line B¹ would be acceptable to the person responsible for the change. Thus, the line B¹ is included in the merged file O, along with the comment//{Deleted change} to indicate that the rules believe the line should be deleted, but that confirmation should be provided. The rules determine that the merged file O comprises the lines A,C from the second wizard-produced file. Under these circumstances it may be determined that line B was added by the first application of the wizard to the source file, but not the second, and thus (unmodified, e.g. “original”) line B is not included in the merged file O.

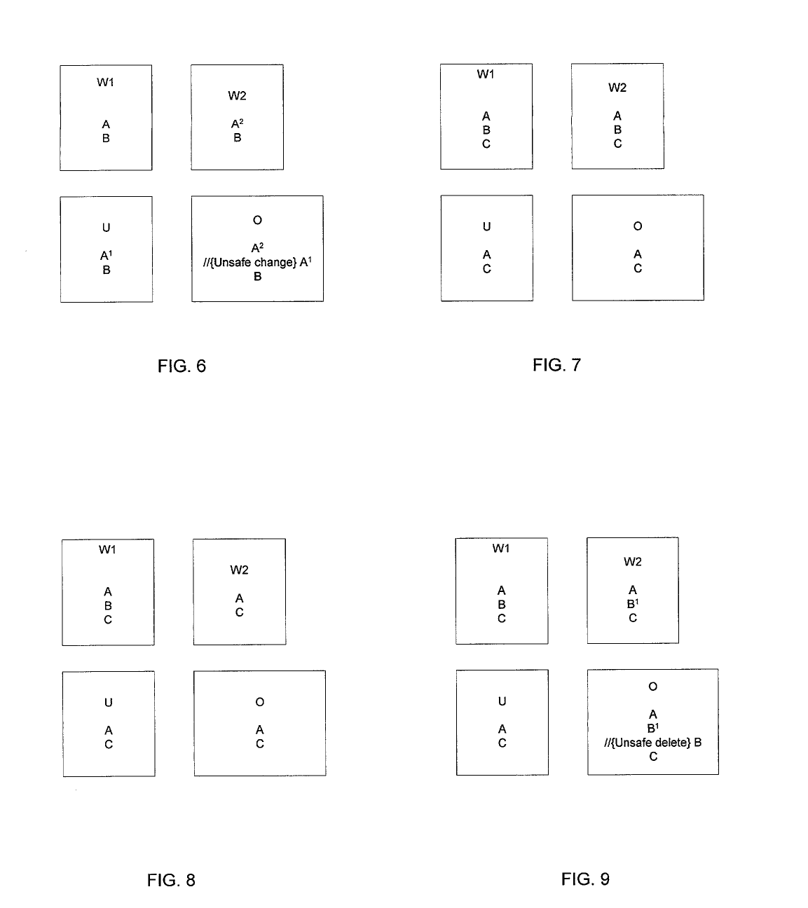

FIG. 6 shows an embodiment of merge rules 106 to merge the contents of the second wizard-produced file W2 and the user-modified file U, when W2 and U comprise different modified versions of the same line A from W1. The user-modified file U comprises lines A¹, B, , where A¹ represents a modified version of line A of the first wizard-produced file. In other words, line A¹ occupies the same relative location in U as line A did in W1.

The second wizard-produced file W2 comprises the same line B as file U, and line A² in the same relative location as line A in file W1 and line A¹ in file U. The first wizard-produced file comprises lines A,B. Thus, the user modifications to the first wizard-produced file W1 comprises modification of line A. It is not possible to know with certainty whether or not the changes comprised by line A¹ should be included in the merged file O. Thus, the line A¹ is included in the merged file O, along with the comment //{Unsafe change} to indicate that the rules believe the confirmation should be provided as to whether or not to include the changes. The rules determine that the merged file O comprises the lines A²,B from the second wizard-produced file. Under these circumstances it may be determined that line A was added by the first application of the wizard to the source file, but not the second, and thus (unmodified, e.g. “original”) line A is not included in the merged file O.

FIG. 7 shows an embodiment of merge rules 106 to merge the contents of the second wizard-produced file W2 and the user-modified file U, when a line B is deleted in U but is present in both W1 and W2. The user-modified file U comprises lines A,C, and the second wizard-produced file W2 comprises the same lines A,C and additional line B not found in the user-modified file U. The first wizard-produced file comprises lines A,B,C. Thus, the user modifications to the first wizard-produced file W1 comprises deletion of line B. The rules determine that the merged file O comprises the lines A,C from the second wizard-produced file, and the line B is not included. Under these circumstances it may be determined that line B was added by both the first and second applications of the wizard to the source file, and that this line should not be present in the final merged file because it was deleted from the user-modified file U.

FIG. 8 shows an embodiment of merge rules 106 to merge the contents of the second wizard-produced file W2 and the user-modified file U, when neither U nor W2 comprise a line which was included in file W1. The user-modified file U comprises lines A,C, and the second wizard-produced file W2 comprises the same lines A,C. The first wizard-produced file comprises lines A,B, C. Thus, the user modifications to the first wizard-produced file W1 comprises deletion of line B. The rules determine that the merged file O comprises the lines A,C from the second wizard-produced file. Under these circumstances it may be determined that line B was added by the first application of the wizard to the source file, but not the second, also that the user-modifications deleted the line B. Thus line B is not included in the merged file O.

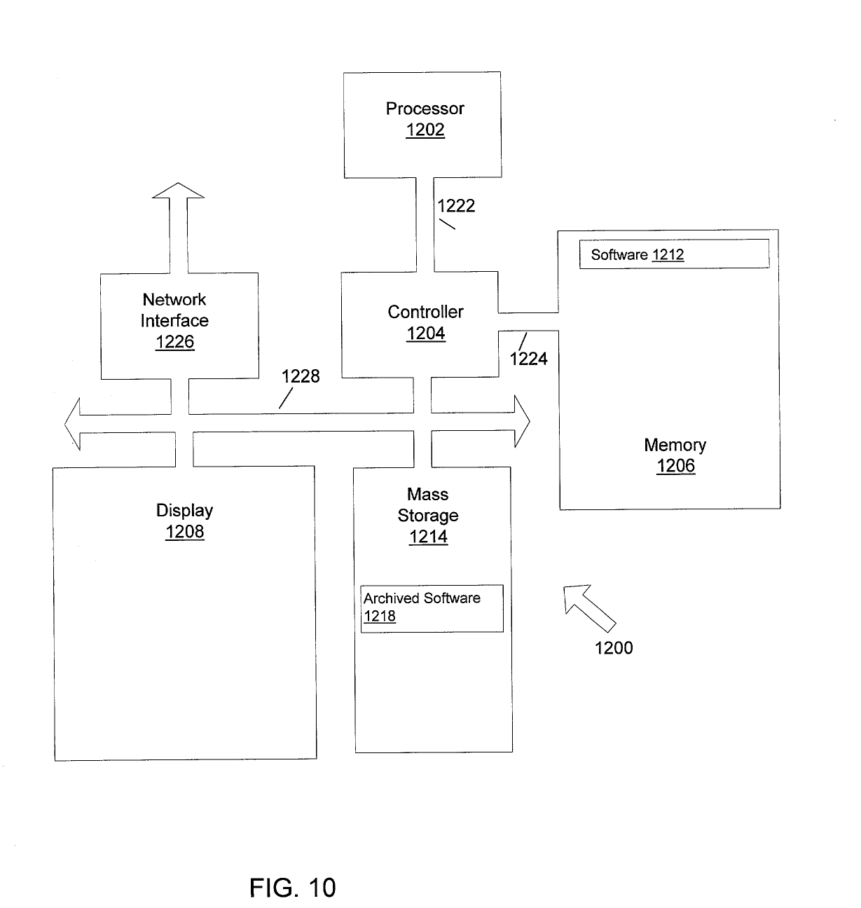

FIG. 9 shows an embodiment of merge rules 106 to merge the contents of the second wizard-produced file W2 and the user-modified file U, when W2 contains a line B¹ in the same relative position as a line B in W1, but U does not contain line B. The user-modified file U comprises lines A,C, and the second wizard-produced file W2 comprises the same lines A,C and additional lines B¹ not found in the user-modified file U. The first wizard-produced file comprises line B in the same relative position as line B¹. Thus, the user modifications to the first wizard-produced file W1 comprises deletion of line B. It is not possible to know with certainty whether or not deleting the line B would be acceptable to the person responsible for the change. Thus, the line B is included in the merged file O, along with the comment//{Unsafe delete} to indicate that the rules believe the line should be deleted, but that confirmation should be provided. The rules determine that the merged file O comprises the lines A,B¹,C from the second wizard-produced file. Under these circumstances it may be determined that line B was added by the first application of the wizard to the source file, but not the second, and the user modifications removed line B.

FIG. 10 shows an apparatus embodiment 1200 in accordance with the present invention. Embodiment 1200 comprises a processor 1202 coupled to a controller 1204 by way of a processor bus 1222, commonly referred to as a front side bus. Bus controller 1204 is coupled to memory 1206 via memory bus 1224. Bus controller 1204 is also coupled to various peripheral devices such as mass storage 1214, network interface 1226, and display 1208 via I/O bus 1228. Network interface 1226 provides apparatus 1200 with access to networks such as the Internet or corporate intranets. Memory 1206 stores a software embodiment 1212 to perform operations in accordance with the present invention. Software 1212 may be stored in memory 1206 in a form suitable for access and execution by processor 1202. An archived loadable form 1218 of software 1212 may be stored by mass storage 1214 for loading into memory 1206 for execution by processor 1202. Mass storage 1214 may comprise any form of non-volatile memory including hard drives, CD ROM drives, ZIP drives, diskettes, and so on.

Memory 1206 is typically a form of random access memory (RAM) such as a DRAM, flash memory, SDRAM, and so on. Memory 1206 supplies the instructions of software 1212 stored therein to processor 1202 for execution. Execution of software embodiment 1212 by processor 1202 may result in a process to merge sources of information in accordance with the present invention.

Embodiments of the present invention may be implemented in hardware or software, or a combination of both. Embodiments of the invention may be implemented as hardware circuits, or as computer programs executing on programmable systems comprising at least one processor and a data storage system (comprising volatile and/or non-volatile memory). The programmable system may further comprise at least one input device and at least one output device. The at least one processor may comprise, for example, a digital signal processor (DSP), a microcontroller, an application specific integrated circuit (ASIC), or a general-purpose microprocessor.

The instructions comprising the operations of the present invention may be implemented in a high level procedural or object oriented programming language and/or assembly or machine language, if desired. In fact, the invention is not limited in scope to any particular programming language. The language may be a compiled or interpreted language.

The instructions comprising the operations of the present invention may be stored on a removable storage media or device (e.g., floppy disk drive, read only memory (ROM), CD-ROM device, flash memory device, digital versatile disk (DVD), or other storage device) readable by a general or special purpose programmable processing system, for configuring and operating the processing system to perform the procedures described herein. Embodiments of the invention may also be considered to be implemented as a machine-readable storage medium, configured for use with a processing system, where the storage medium so configured causes the processing system to operate in a specific and predefined manner to perform the operations described herein.

While certain features of the invention have been illustrated as described herein, many modifications, substitutions, changes and equivalents will now occur to those skilled in the art. It is, therefor, to be understood that the appended claims are intended to cover all such embodiments and changes as fall within the true spirit of the invention.

What is claimed is:

1. A method comprising:
comparing a first and second files; and
merging the first and second files according to the contents of a third file to produce a merged file, priority given to preserving the differences between the first and third files.

2. The method of claim 1 wherein comparing the first and second files further comprises:
comparing a user-modified file with a first wizard-generated file.

3. The method of claim 2 wherein merging the first and second files according to the contents of a third file further comprises:
merging the first and second files according to the contents of a second wizard-generated file generated prior to the first wizard-generated file.

4. The method of claim 1 in which giving priority to preserving the differences between the first and third files further comprises:
when a line is the same in the second and third files, and present but having first changes in the first file, inserting the line with the first changes into the merged file.

5. The method of claim 1 in which giving priority to preserving the differences between the first and third files further comprises:
when a line is present in the third file and deleted in the second file, and present but having first changes in the third file, inserting the first changes into the merged file with an indication that the first changes may not belong in the merged file.

6. The method of claim 1 in which giving priority to preserving the differences between the first and third files further comprises:
when a line is present in the third file and present but having first changes in the second file, and present but having second changes in the first file, inserting the first changes into the merged file, and inserting the second changes into the merged file with an indication that the second changes may not belong in the merged file.

7. The method of claim 1 in which giving priority to preserving the differences between the first and third files further comprises:
when a line is present in both the second and third files, but deleted in the first file, not inserting the line into the merged file.

8. The method of claim 1 in which giving priority to preserving the differences between the first and third files further comprises:
when a line of the third file is present in the second file but having first changes in the second file, and the line is deleted from the first file, inserting the line having first changes into the merged file, and inserting the line into the merged file with an indication that the line may not belong in the merged file.
